(19) United States
(12) Patent Application Publication
(10) Pub. No.: US 2003/0033960 A1
(43) Pub. Date: Feb. 20, 2003

(54) Line trimmer, biodegradable trim line for use therewith, and method of making same

(76) Inventor: Michael E. Hudzinski, Solon, OH (US)

Correspondence Address: Michael E. Hudzinski, FAY, SHARPE, FAGAN, MINNICH & McKEE, LLP, Seventh Floor, 1100 Superior Avenue, Cleveland, OH, 44114-2518, US

(21) Appl. No.: 10/222,497

(22) Filed: Aug. 16, 2002

Related U.S. Application Data
(60) Provisional application No. 60/313,287, filed on Aug. 17, 2001.

(51) Int. Cl. C09D 103/00; A01D 34/13; A01D 34/24

(52) U.S. Cl. 106/206.1; 56/286

(57) ABSTRACT

A flexible cutting member is provided for use with an associated line trimmer device. The cutting member is formed of a biodegradable plastic formed of a hydrophobic thermoplastic modified starch derived from corn, wheat, or a wheat/corn blend. A combination line trimmer and biodegradable trim line is further provided. Additionally, a method is provided for producing trim line for use in an associated line trimmer including providing a biodegradable plastic material and extruding the material through a die into an elongate cylindrical flexible cutting member.

### CROSS-REFERENCE TO RELATED APPLICATION

This application claims the benefit of U.S. Provisional Application Serial No. 60/313,287, filed Aug. 17, 2001.

### BACKGROUND OF THE INVENTION

Line trimmers or “weed whackers” have become popular with both homeowners and commercial lawn care services. These tools are typically used to edge around lawns, flower beds, walkways and the like to produce a crisp and aesthetically pleasant interface between the lawn surface and border areas. Power tools of this type are also useful for trimming tall grass and other plants in areas where the use of a mower would be either impractical or inconvenient.

Typical line trimmers consist of an elongate shaft with a motor on one end and a rotating cutting head on the other end. Typically, the motor is a two-stroke gas/oil engine. Some line trimmers, however, are powered by an electric motor. The shaft is essentially a hollow rigid conduit and contains a flexible drive shaft within for connecting the motor to the cutting head. The cutting head typically contains one or more sections of trim line extending radially outwardly from the cutting head body. As the head spins, the trim line whips at the vegetation to cut it off in the area of contact. The trim line is contained within the cutting head body on a spool so that new line can be payed out from the body as necessary or desired. Some cutting head bodies are provided with a “bump” pay out mechanism so that the line trimmer operator can pay out additional trim line by simply tapping the underside of the body on any hard surface while the cutting head rotates.

The trim line must meet certain performance parameters in order to function properly. It has been found that plastic trim line works well because this material is sufficiently flexible so that the trim line can be rolled onto spools while yet being sufficiently strong so that it does not break during use.

One disadvantage of plastic trim line, however, is that it is not biodegradable. Although, arguably, the mechanical properties of plastic degrade in the sun over time by the plastic becoming brittle, for example, it never actually breaks down into the raw materials of nature. A large amount of trim line is typically left behind by users because collecting broken pieces of the line is inconvenient or impractical. This practice adds to the unsustainable pollution problem.

In addition to the problem of traditional plastics polluting and littering the land, air, and water, they require crude oil and other petroleum products in their manufacture. Many products are made from petroleum-based plastics. Recognizing the need for a reduction in the nation's dependence on foreign oil in general, an Interagency Council on Biobased Products and Bioenergy was formed by Executive Order 13134. The primary goal of the Executive Order is to triple the use of bioenergy and biobased products by 2010 via commercial utilization of renewable farm and forestry resources as major sources of affordable electricity, fuels, chemicals, and other materials. The Executive Order is an initiative toward the use of natural biodegradable ingredients in the manufacture of plastics rather than man-made petrochemical compounds.

It is desirable, therefore, to provide a biodegradable trim line for use in line trimmers and other power tools. In that way, broken pieces of trim line can be left behind without the concern of causing damage to the environment. Further, biodegradable trim line formed from bioplastic material, rather than from petroleum-based plastics, will reduce the nation's consumption and demand for foreign oil.

The expression “biodegradable” is used herein in accordance with its commonly accepted definition, namely, the ability to break down, safely and relatively quickly, by biological means, into the raw materials of nature and disappear into the environment. Preferably, substantially all of the carbon mineralizes and is converted into fixed, or neutral, carbon dioxide so as to not contribute to an increase in greenhouse gases.

### SUMMARY OF THE INVENTION

In accordance with another embodiment of the invention, a flexible cutting member for use in an associated line trimmer device is provided. The flexible cutting member is formed of a biodegradable plastic. The biodegradable plastic is preferably formed of a starch resin derived from corn, wheat, or a wheat/corn blend. Further, more particularly, the biodegradable plastic is a hydrophobic thermoplastic modified starch derived from corn, wheat, or a wheat/corn blend.

In accordance with yet another embodiment of the invention, an article of manufacture is provided including, in combination, a line trimmer and a flexible biodegradable cutting member. Preferably, the biodegradable flexible cutting member is formed of a hydrophobic thermoplastic modified starch derived from corn, wheat, or a wheat/corn blend.

In accordance with a further embodiment of the invention, a method of producing trim line for use in an associated line trimmer device is provided including providing a biodegradable material and extruding the biodegradable material through a die in a shape adapted for use with said associated line trimmer device. Preferably, the step of providing the biodegradable material includes providing a hydrophobic thermoplastic modified starch.

### BRIEF DESCRIPTION OF THE DRAWINGS

The foregoing aspects and other features of the invention are explained in the following description, taken in connection with the accompanying drawings, wherein:

FIG. 1 is perspective view of a line trimmer having a rotary cutting head carrying a biodegradable flexible cutting member in accordance with the present invention;

FIG. 2A is a cross-sectional view of the flexible cutting member illustrated in FIG. 1; and,

FIG. 2B is a cross-sectional view of an alternative embodiment of the biodegradable flexible cutting member in accordance with the present invention.

### DETAILED DESCRIPTION OF THE PREFERRED EMBODIMENTS

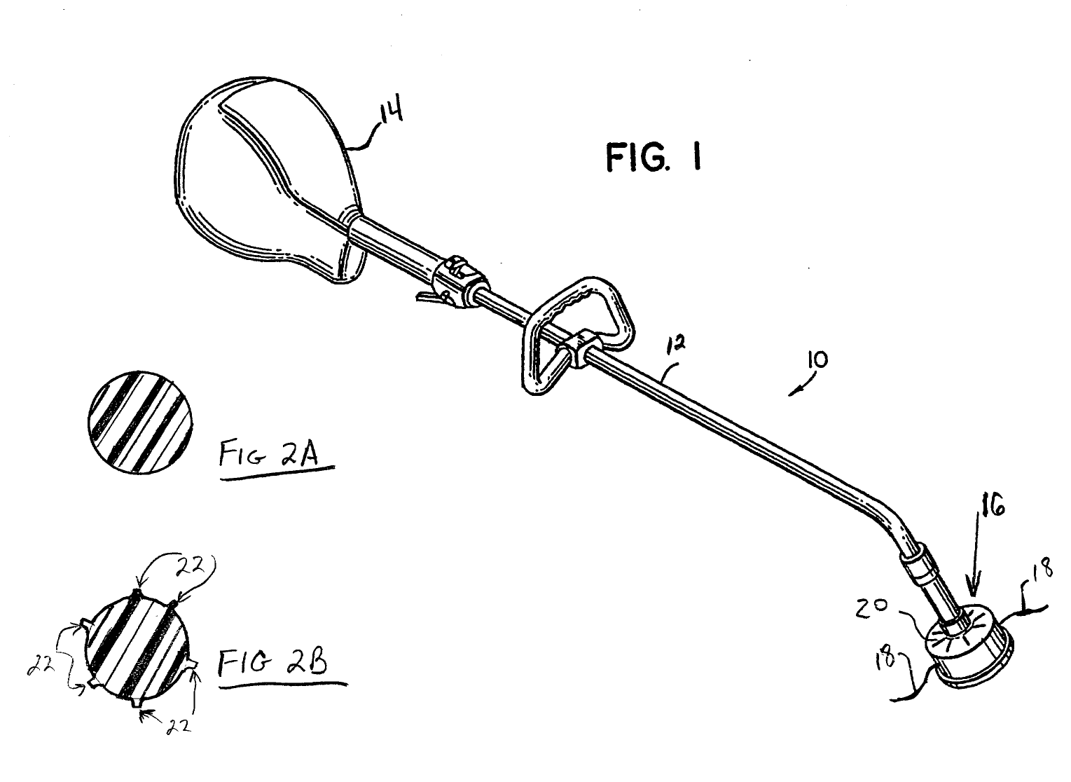

Referring now to the drawings wherein the figures are for purposes of explaining the preferred embodiments only and not for purposes of limiting same, FIG. 1 shows a line trimmer 10 including an elongate shaft 12 with a motor 14 on one end and a rotating cutting head 16 on the other end. The motor can be an electric motor or a gas/oil engine. The shaft 12 is essentially a hollow rigid conduit and contains a flexible drive shaft within for connecting the motor 14 to the cutting head 16.

In accordance with the present invention, the cutting head 16 carries one or more sections of elongate biodegradable trim line cutting members 18 extending radially outwardly from the cutting head body 20. As the head spins, the trim line or cutting members 18 whip at the vegetation to cut it off in the area of contact in a well known manner. The trim line is preferably contained within the cutting head body and carried on a spool device so that new biodegradable trim line can be paid out from the body as necessary or desired.

The biodegradable trim line 18 for use in line trimmers, weed whackers, landscaping power tools, and the like is made of a hydrophobic, thermoplastic modified starch resin such as described in U.S. Pat. No. 5,869,647, the teachings of which are incorporated by reference. A soy-based dye can be blended with the cornstarch resin in order to produce trim lines having a desired color. Preferably, the starch resin is mixed until the desired properties are achieved and then extruded through dyes having suitable circular or other cross sectional configurations to generate elongate trim line pieces.

Preferably, the hydrophobic, thermoplastic modified starch resin supplied by Evercorn, Inc. of Lansing, Mich. is used. This material is readily processable on conventional plastics processing equipment such as extenders, injection molders, etc. However, other agricultural/industrial producers are used as a source of the resin including Cargill Dow LLC (“NatureWorks™ PLA”-polyactide polymer), and Eastman Kodak. Presently, cornstarch resin is used in other applications such as fast-food serving containers, disposable tableware, trash bags, and golf tees.

The biodegradable trim line according to the present invention has all of the desirable properties of plastic trim line cutting members including the necessary mechanical strength (Maximum Psi) and stiffness (Young's Modulus) properties necessary to function to cut vegetation in a typical line trimmer device. The subject biodegradable trim line performs like plastic, feels like plastic, and looks like plastic. However, the biodegradable trim line according to the present invention degrades naturally into the raw materials of nature and disappears into the environment, preferably over a period of several weeks.

The modified starch resin is available in the form of pellets. In accordance with the invention, the pellets are processed using conventional plastics processing equipment such as blinders, injection molders, and extruders, combined with calcium and/or titanium and then extruded through a suitable extrusion dye. The extruded biodegradable cutting member has a suitable round diameter of about 0.080 inches and a length of about 50 feet or more. If desired, the elongate biodegradable cutting member can be wound directly onto a suitable spool for commercial/retail sale and ready installation onto a desired line trimmer of appropriate type.

Preferably, the shape of the extrusion dye and therefore configuration of the trim line surface is circular as shown in FIG. 2A. Alternatively, in order to provide a more aggressive cut, the extrusion dye may be altered in shape somewhat such as to provide a “star-like” pattern as illustrated in FIG. 2B. Trim line produced using the extrusion dye of FIG. 2B is advantageous because the contact force of the trim line against the vegetation is concentrated along the sharp raised ribs 22 formed along the outer circumference of the product. In the illustrated example, six (6) ribs are provided. However, other numbers of ribs or a spiral twist can be used as desired.

Having thus described the preferred embodiments of the invention, it is now claimed:

1. In combination:
a line trimmer; and,
a biodegradable trim line.

2. The combination according to claim 1 wherein the trim line is formed of a starch resin.

3. The combination according to claim 1 wherein the trim line is formed of a cornstarch resin mixed with at least one of calcium and titanium.

4. The combination according to claim 3 wherein the trim line has a circular cross-section.

5. The combination according to claim 3 wherein the trim line has a star-shaped cross-section.

6. A flexible cutting member for use in an associated line trimmer device, the flexible cutting member being formed of a biodegradable plastic.

7. The flexible cutting member according to claim 6 wherein the biodegradable plastic is a cornstarch resin.

8. The flexible cutting member according to claim 7 wherein the biodegradable plastic is a cornstarch resin combined with at least one of calcium and titanium.

9. The flexible cutting member according to claim 8 wherein the biodegradable plastic is a cornstarch resin combined with a soy dye to produce a colored cutting member.

10. The flexible cutting member according to claim 6 wherein the biodegradable plastic is a hydrophobic thermoplastic modified starch.

11. The flexible cutting member according to claim 10 wherein the biodegradable plastic is a hydrophobic thermoplastic modified starch containing a miscible biodegradable plasticizer.

12. The flexible cutting member according to claim 11 wherein the miscible biodegradable plasticizer is selected from the group including biodegradable esters miscible esters of said modified starch.

13. The flexible cutting member according to claim 11 wherein the hydrophobic thermoplastic modified starch further contains a compatible filler.

14. The flexible cutting member according to claim 13 wherein:
the miscible biodegradable plasticizer is selected from the group including biodegradable esters miscible with esters of said modified starch; and,
the compatible filler is selected from the group including talc and similar inorganic structural fillers.

15. A method of producing trim line for use in an associated line trimmer device comprising:
providing a biodegradable plastic material; and,
extruding the biodegradable material through a die in a shape adapted for use with said associated line trimmer device.

16. The method according to claim 15 wherein the step of providing the biodegradable plastic material includes providing a biodegradable material formed of a hydrophobic thermoplastic modified starch resin.

17. The method according to claim 16 wherein the step of providing the biodegradable plastic material includes providing the biodegradable material formed of a cornstarch resin mixed with at least one of calcium and titanium.

18. The method according to claim 15 wherein the step of extruding the biodegradable material includes extruding the biodegradable material through a die having a circular cross-section.

19. The method according to claim 15 wherein the step of extruding the biodegradable material includes extruding the biodegradable material through a die having a star-shaped cross-section.

20. The method according to claim 15 wherein the step of providing the biodegradable material includes providing a cornstarch resin combined with a soy dye to produce a colored trim line.
